(19) United States
(12) Patent Application Publication
(10) Pub. No.: US 2016/0278416 A1
(43) Pub. Date: Sep. 29, 2016

(54) METHODS FOR PRODUCING WATER SOLUBLE OIL PALM LEAF POWDER AND CONCENTRATE

(71) Applicant: MALAYSIAN PALM OIL BOARD (MPOB), Kajang (MY)

(72) Inventors: Halimah MUHAMAD, Kajang (MY); Nicholas Mun Hoe KHONG, Kajang (MY); Wee Ting LAI, Kajang (MY)

(21) Appl. No.: 14/856,410

(22) Filed: Sep. 16, 2015

(30) Foreign Application Priority Data
Mar. 24, 2015 (MY) PI 2015000731

(51) Int. Cl. A23F 3/00; C11B 1/04; A23F 3/40; C11B 1/10; B01J 13/02

(52) U.S. Cl. CPC A23L 1/3002; C11B 1/108; C11B 1/04; B01J 13/02; A23F 3/405; A23V 2002/00

(57) ABSTRACT

The present invention relates to methods for producing water soluble oil palm leaf powder and concentrate. The most preferred method includes the steps of (a) cleaning the leaves with water or an acid with pH lower than 5.5 and salts to produce an extract, (b) extracting the oil palm leaves with a solvent which has polarity index above 2.5 such as methanol, ethanol or ethyl acetate or any combination thereof, especially catechins or ethanol and water which are generally recognized as safe (GRAS) for food consumption (c) filtering and/or centrifuging the extract, (d) sterilizing the extract and (e) microencapsulating the extract from step (d) to form the water soluble oil palm leaf powder and concentrate.

### FIELD OF INVENTION

The present invention relates to methods for producing water soluble oil palm leaf powder and concentrate.

### BACKGROUND OF THE INVENTION

Oil palm leaves are the largest biomass produced from the oil palm industry which is still underutilized especially for the food industry.

However, it is noted that there is no oil palm leaves-derived water soluble powder or water dispersible powder available in the market.

Oil palm leaf extract is not water soluble and hence have limited applications. Researchers in this field of invention have found that dried oil palm leaf extract has weak powder properties and commonly appear in a paste form and that oil palm leaf extract is not readily applicable for product formulations, incorporation and supplementation.

### SUMMARY OF INVENTION

Accordingly, the present invention provides a method for producing water soluble oil palm leaf powder and concentrate, wherein the method includes the steps of (a) cleaning the leaves with water or an acid with pH lower than 5.5 and salts to produce an extract, (b) extracting the oil palm leaves with a solvent which has polarity index above 2.5 such as methanol, ethanol or ethyl acetate which are able to retrieve phenolics and flavonoids or any combination thereof, especially catechins or ethanol and water which are generally recognized as safe (GRAS) for food consumption, (c) filtering and/or centrifuging the extract, (d) sterilizing the extract and (e) microencapsulating the extract from step (d) to form the water soluble oil palm leaf powder and concentrate.

Further it is also provides a method for producing water soluble oil palm leaf powder and concentrate, wherein the method includes the steps of (a) cleaning the leaves with water or an acid with pH lower than 5.5 and salts to produce an extract, (b) extracting the oil palm leaves with a solvent which has polarity index above 2.5 such as methanol, ethanol or ethyl acetate which are able to retrieve phenolics and flavonoids, or any combination thereof, especially catechins or ethanol and water which are generally recognized as safe (GRAS) for food consumption, (c) filtering and/or centrifuging the extract, (d) adding additives and/or stabilisers such as glucose, sucrose, fructose, starch, sodium hydroxide, sodium chloride, vitamins and minerals and (e) microencapsulating the extract from step (d) to form water soluble oil palm leaf powder and concentrate.

Also provided is a method for producing water soluble oil palm leaf powder and concentrate, wherein the method includes the steps of (a) cleaning the leaves with water or an acid with pH lower than 5.5 and salts to produce an extract, (b) extracting the oil palm leaves with a solvent which has polarity index above 2.5 such as methanol, ethanol or ethyl acetate or any combination thereof, especially catechins or ethanol and water which are generally recognized as safe (GRAS) for food consumption, (c) filtering and/or centrifuging the extract, (d) adding a buffer system or buffering agent such as citric acid, acetic acid, phosphate buffer, acetate buffer in order to maintain the pH of the powder to be the range of pH 3-8 and (e) microencapsulating the extract from step (d) to form water soluble oil palm leaf powder and concentrate.

Further provided is a method for producing water soluble oil palm leaf powder and concentrate, wherein the method includes the steps of (a) cleaning the leaves with water or an acid with pH lower than 5.5 and salts to produce an extract, (b) extracting the oil palm leaves with a solvent which has polarity index above 2.5 such as methanol, ethanol or ethyl acetate or any combination thereof, especially catechins or ethanol and water which are generally recognized as safe (GRAS) for food consumption, (c) filtering and/or centrifuging the extract, (d) adding an encapsulation agent and/or stabilisers such as maltodextrin, cyclodextrin, gelatin, collagen, sodium caseinate, gum such as Arabic, locust bean, Ghatti, guar, Steaculia, Karaya, Tragacanth, alginates, agar-agar, pectin, carrageenan, protein hydrolysates or any combination thereof and (e) microencapsulating the extract from step (d) to form water soluble oil palm leaf powder and concentrate.

Also provided is a method for producing water soluble oil palm leaf powder and concentrate, wherein the method includes the steps of (a) cleaning the leaves with water or an acid with pH lower than 5.5 and salts to produce an extract, (b) extracting the oil palm leaves with a solvent which has polarity index above 2.5 such as methanol, ethanol or ethyl acetate or any combination thereof, especially catechins or ethanol and water which are generally recognized as safe (GRAS) for food consumption, (c) filtering and/or centrifuging the extract, (d) sterilizing the extract and (e) removing moisture from the extract from step (d) to form the water soluble oil palm leaf powder and concentrate.

Further provided is a method for producing water soluble oil palm leaf powder and concentrate, wherein the method includes the steps of (a) cleaning the leaves with water or an acid with pH lower than 5.5 and salts to produce an extract, (b) extracting the oil palm leaves with a solvent which has polarity index above 2.5 such as methanol, ethanol or ethyl acetate or any combination thereof, especially catechins or ethanol and water which are generally recognized as safe (GRAS) for food consumption, (c) filtering and/or centrifuging the extract, (d) adding additives and/or stabilisers such as glucose, sucrose, fructose, starch, sodium hydroxide, acidity regulator, sodium chloride, vitamins and minerals and (e) removing moisture from the extract from step (d) to form the water soluble oil palm leaf powder and concentrate.

Also provided is a method for producing water soluble oil palm leaf powder and concentrate, wherein the method includes the steps of (a) cleaning the leaves with water or an acid with pH lower than 5.5 and salts to produce an extract, (b) extracting the oil palm leaves with a solvent which has polarity index above 2.5 such as methanol, ethanol or ethyl acetate or any combination thereof, especially catechins or ethanol and water which are generally recognized as safe (GRAS) for food consumption, (c) filtering and/or centrifuging the extract, (d) adding a buffer system or buffering agent such as citric acid, acetic acid, phosphate buffer, acetate buffer in order to maintain the pH of the powder to be the range of pH 3-8 and (e) removing moisture from the extract from step (d) to form the water soluble oil palm leaf powder and concentrate.

Last but not least, the present invention also provides a method for producing water soluble oil palm leaf powder and concentrate, wherein the method includes the steps of (a) cleaning the leaves with water or an acid with pH lower than 5.5 and salts to produce an extract, (b) extracting the oil palm leaves with a solvent which has polarity index above 2.5 such as methanol, ethanol or ethyl acetate or any combination thereof, especially catechins or ethanol and water which are generally recognized as safe (GRAS) for food consumption, (c) filtering and/or centrifuging the extract, (d) adding an encapsulation agent and/or stabilisers such as maltodextrin, cyclodextrin, gelatin, collagen, sodium caseinate, gum such as Arabic, locust bean, Ghatti, guar, Steaculia, Karaya, Tragacanth, alginates, agar-agar, pectin, carrageenan, protein hydrolysates or any combination thereof and (e) microencapsulating the extract from step (d) to form water soluble oil palm leaf powder and concentrate.

### BRIEF DESCRIPTION OF THE DRAWINGS

FIG. 1 shows the observations on the solubility of different oil palm leaves (OPAL) preparations upon vigorous stirring and centrifugation wherein A shows water soluble OPAL, B shows water dispersible OPAL and C shows crude OPAL leaves;

FIG. 2 shows the moisture content, percent solubility and percent dispensability of water soluble OPAL, water dispersible OPAL and crude OPAL leaves; and

FIG. 3 shows the overall preference of six tea beverages characterized by 80 non-trained panelists.

### DETAILED DESCRIPTION OF THE PREFERRED EMBODIMENTS

The present invention relates to methods for producing water soluble oil palm leaf powder and concentrate.

In the preferred embodiments of the present invention, a method for producing water soluble oil palm leaf powder and concentrate, wherein the method includes the steps of:

(a) cleaning the leaves with water or an acid with pH lower than 5.5 and salts to produce an extract;

(b) extracting the oil palm leaves with a solvent which has polarity index above 2.5 such as methanol, ethanol or ethyl acetate or any combination thereof, especially catechins or ethanol and water which are generally recognized as safe (GRAS) for food consumption;

(c) filtering and/or centrifuging the extract;

(d) sterilizing the extract; and

(e) microencapsulating the extract from step (d) to form the water soluble oil palm leaf powder and concentrate.

The leaves in step (a) may be cleansed by washing, soaking, immersing, stirring with water or an acid with pH lower than 5.5 such as acetic acid, lactic acid, citric acid, tartaric acid and malic acid and salts such as sodium chloride, sodium acetate, potassium chloride and magnesium chloride and/or any combinations thereof.

Step (a) may be aided by decellularization means such as juicing, stirring, mixing, blending, heating, steam distillation, homogenization, sonication, microwave, pulse-electric field, pressurised, supercritical fluid, ionic fluid and subcritical fluid.

The leaves in step (b) may be dried and separated to different size ranges, distinctively: water insoluble range (>500 μm), water dispersible range (>100 μm) and extraction range.

Step (d) may be conducted using means such as autoclaving, pasteurization, UHT, tyndallisation, retort, boiling, cooking, sonication, microwave, pulse-electric field or radiations.

The leaves may be fresh, dried, fermented, rolled, pressed, crushed and/or any combination thereof.

The leaves used may be are those from coconut and other edible palms such as areca (betel), date, acai, peach, snake, Butia, Chilean Wine, Saw Palmetto, Guadalupe, California Fan palms and those from the edible species of several species of Acrocomia, Actinorhytis, Allagoptera, Astrocaryum, Attalea, Bactris, Borassus, Calamus, Carpoxylon, Chamaerops, Clinostigma, Copernicia, Cryosophila, Daemonorops, Dypsis, Gulubia, Hyphaene, Jubaeaopsis, Latania, Loxococcos, Nypa, Oenocarpus, Parajubaea, Phoenix, Dactylifera, Pinanga, Ptychococcus, Sabal and Syagrus.

The use of the water soluble oil palm leaf powder and concentrate formulated with water dispersible oil palm as food ingredient, beverage ingredient, aroma and flavoring agent, active ingredient, nutricosmetics, cosmetics, cosmeceutics, toiletry ranges, supplements, instant food and nutritional formulations, natural preservative, oxidative retardant, functional food, pharmaceutics, additives, colorant and animal feed ingredient.

In a further embodiment of the present invention, a method for producing water soluble oil palm leaf powder and concentrate, wherein the method includes the steps of:

(a) cleaning the leaves with water or an acid with pH lower than 5.5 and salts to produce an extract;

(b) extracting the oil palm leaves with a solvent which has polarity index above 2.5 such as methanol, ethanol or ethyl acetate or any combination thereof, especially catechins or ethanol and water which are generally recognized as safe (GRAS) for food consumption;

(c) filtering and/or centrifuging the extract;

(d) adding additives and/or stabilisers such as glucose, sucrose, fructose, starch, sodium hydroxide, acidity regulator, sodium chloride, vitamins and minerals; and

(e) microencapsulating the extract from step (d) to form water soluble oil palm leaf powder and concentrate.

The leaves in step (a) may be cleansed by washing, soaking, immersing, stirring with water or an acid with pH lower than 5.5 such as acetic acid, lactic acid, citric acid, tartaric acid and malic acid and salts such as sodium chloride, sodium acetate, potassium chloride and magnesium chloride and/or any combinations thereof.

Step (a) may be aided by decellularization means such as juicing, stirring, mixing, blending, heating, steam distillation, homogenization, sonication, microwave, pulse-electric field, pressurised, supercritical fluid, ionic fluid and subcritical fluid.

The leaves in step (b) may be dried and separated to different size ranges, distinctively: water insoluble range (>500 μm), water dispersible range (>100 μm) and extraction range.

Step (d) may be conducted using means such as autoclaving, pasteurization, UHT, tyndallisation, retort, boiling, cooking, sonication, microwave, pulse-electric field or radiations.

The leaves may be fresh, dried, fermented, rolled, pressed, crushed and/or any combination thereof.

The leaves used may be are those from coconut and other edible palms such as areca (betel), date, acai, peach, snake, Butia, Chilean Wine, Saw Palmetto, Guadalupe, California Fan palms and those from the edible species of several species of Acrocomia, Actinorhytis, Allagoptera, Astrocaryum, Attalea, Bactris, Borassus, Calamus, Carpoxylon, Chamaerops, Clinostigma, Copernicia, Cryosophila, Daemonorops, Dypsis, Gulubia, Hyphaene, Jubaeaopsis, Latania, Loxococcos, Nypa, Oenocarpus, Parajubaea, Phoenix, Dactylifera, Pinanga, Ptychococcus, Sabal and Syagrus.

The use of the water soluble oil palm leaf powder and concentrate formulated with water dispersible oil palm as food ingredient, beverage ingredient, aroma and flavoring agent, active ingredient, nutricosmetics, cosmetics, cosmeceutics, toiletry ranges, supplements, instant food and nutritional formulations, natural preservative, oxidative retardant, functional food, pharmaceutics, additives, colorant and animal feed ingredient.

In a still another embodiment of the present invention, the present invention provides a method for producing water soluble oil palm leaf powder and concentrate, wherein the method includes the steps of:

(a) cleaning the leaves with water or an acid with pH lower than 5.5 and salts to produce an extract;

(b) extracting the oil palm leaves with a solvent which has polarity index above 2.5 such as methanol, ethanol or ethyl acetate or any combination thereof, especially catechins or ethanol and water which are generally recognized as safe (GRAS) for food consumption;

(c) filtering and/or centrifuging the extract;

(d) adding a buffer system or buffering agent such as citric acid, acetic acid, phosphate buffer, acetate buffer in order to maintain the pH of the powder to be the range of pH 3-8; and

(e) microencapsulating the extract from step (d) to form water soluble oil palm leaf powder and concentrate.

The leaves in step (a) may be cleansed by washing, soaking, immersing, stirring with water or an acid with pH lower than 5.5 such as acetic acid, lactic acid, citric acid, tartaric acid and malic acid and salts such as sodium chloride, sodium acetate, potassium chloride and magnesium chloride and/or any combinations thereof.

Step (a) may be aided by decellularization means such as juicing, stirring, mixing, blending, heating, steam distillation, homogenization, sonication, microwave, pulse-electric field, pressurised, supercritical fluid, ionic fluid and subcritical fluid.

The leaves in step (b) may be dried and separated to different size ranges, distinctively: water insoluble range (>500 μm), water dispersible range (>100 μm) and extraction range.

Step (d) may be conducted using means such as autoclaving, pasteurization, UHT, tyndallisation, retort, boiling, cooking, sonication, microwave, pulse-electric field or radiations.

The leaves may be fresh, dried, fermented, rolled, pressed, crushed and/or any combination thereof.

The leaves used may be are those from coconut and other edible palms such as areca (betel), date, acai, peach, snake, Butia, Chilean Wine, Saw Palmetto, Guadalupe, California Fan palms and those from the edible species of several species of Acrocomia, Actinorhytis, Allagoptera, Astrocaryum, Attalea, Bactris, Borassus, Calamus, Carpoxylon, Chamaerops, Clinostigma, Copernicia, Cryosophila, Daemonorops, Dypsis, Gulubia, Hyphaene, Jubaeaopsis, Latania, Loxococcos, Nypa, Oenocarpus, Parajubaea, Phoenix, Dactylifera, Pinanga, Ptychococcus, Sabal and Syagrus.

The use of the water soluble oil palm leaf powder and concentrate formulated with water dispersible oil palm as food ingredient, beverage ingredient, aroma and flavoring agent, active ingredient, nutricosmetics, cosmetics, cosmeceutics, toiletry ranges, supplements, instant food and nutritional formulations, natural preservative, oxidative retardant, functional food, pharmaceutics, additives, colorant and animal feed ingredient.

In a further embodiment of the present invention, there is provided a method for producing water soluble oil palm leaf powder and concentrate, wherein the method includes the steps of:

(a) cleaning the leaves with water or an acid with pH lower than 5.5 and salts to produce an extract;

(b) extracting the oil palm leaves with a solvent which has polarity index above 2.5 such as methanol, ethanol or ethyl acetate or any combination thereof, especially catechins or ethanol and water which are generally recognized as safe (GRAS) for food consumption;

(c) filtering and/or centrifuging the extract;

(d) adding an encapsulation agent and/or stabilisers such as maltodextrin, cyclodextrin, gelatin, collagen, sodium caseinate, gum such as Arabic, locust bean, Ghatti, guar, Steaculia, Karaya, Tragacanth, alginates, agar-agar, pectin, carrageenan, protein hydrolysates or any combination thereof; and

(e) microencapsulating the extract from step (d) to form water soluble oil palm leaf powder and concentrate.

The leaves in step (a) may be cleansed by washing, soaking, immersing, stirring with water or an acid with pH lower than 5.5 such as acetic acid, lactic acid, citric acid, tartaric acid and malic acid and salts such as sodium chloride, sodium acetate, potassium chloride and magnesium chloride and/or any combinations thereof.

Step (a) may be aided by decellularization means such as juicing, stirring, mixing, blending, heating, steam distillation, homogenization, sonication, microwave, pulse-electric field, pressurised, supercritical fluid, ionic fluid and subcritical fluid.

The leaves in step (b) may be dried and separated to different size ranges, distinctively: water insoluble range (>500 μm), water dispersible range (>100 μm) and extraction range.

Step (d) may be conducted using means such as autoclaving, pasteurization, UHT, tyndallisation, retort, boiling, cooking, sonication, microwave, pulse-electric field or radiations.

The leaves may be fresh, dried, fermented, rolled, pressed, crushed and/or any combination thereof.

The leaves used may be are those from coconut and other edible palms such as areca (betel), date, acai, peach, snake, Butia, Chilean Wine, Saw Palmetto, Guadalupe, California Fan palms and those from the edible species of several species of Acrocomia, Actinorhytis, Allagoptera, Astrocaryum, Attalea, Bactris, Borassus, Calamus, Carpoxylon, Chamaerops, Clinostigma, Copernicia, Cryosophila, Daemonorops, Dypsis, Gulubia, Hyphaene, Jubaeaopsis, Latania, Loxococcos, Nypa, Oenocarpus, Parajubaea, Phoenix, Dactylifera, Pinanga, Ptychococcus, Sabal and Syagrus.

The use of the water soluble oil palm leaf powder and concentrate formulated with water dispersible oil palm as food ingredient, beverage ingredient, aroma and flavoring agent, active ingredient, nutricosmetics, cosmetics, cosmeceutics, toiletry ranges, supplements, instant food and nutritional formulations, natural preservative, oxidative retardant, functional food, pharmaceutics, additives, colorant and animal feed ingredient.

In still another embodiment of the present invention, it is provided a method for producing water soluble oil palm leaf powder and concentrate, wherein the method includes the steps of:

(a) cleaning the leaves with water or an acid with pH lower than 5.5 and salts to produce an extract;

(b) extracting the oil palm leaves with a solvent which has polarity index above 2.5 such as methanol, ethanol or ethyl acetate or any combination thereof, especially catechins or ethanol and water which are generally recognized as safe (GRAS) for food consumption;

(c) filtering and/or centrifuging the extract;

(d) sterilizing the extract; and

(e) removing moisture from the extract from step (d) to form the water soluble oil palm leaf powder and concentrate.

The leaves in step (a) may be cleansed by washing, soaking, immersing, stirring with water or an acid with pH lower than 5.5 such as acetic acid, lactic acid, citric acid, tartaric acid and malic acid and salts such as sodium chloride, sodium acetate, potassium chloride and magnesium chloride and/or any combinations thereof.

Step (a) may be aided by decellularization means such as juicing, stirring, mixing, blending, heating, steam distillation, homogenization, sonication, microwave, pulse-electric field, pressurised, supercritical fluid, ionic fluid and subcritical fluid.

The leaves in step (b) may be dried and separated to different size ranges, distinctively: water insoluble range (>500 μm), water dispersible range (>100 μm) and extraction range.

Step (d) may be conducted using means such as autoclaving, pasteurization, UHT, tyndallisation, retort, boiling, cooking, sonication, microwave, pulse-electric field or radiations.

Step (e) may be conducted by drying and/or dehydrating the extract.

The leaves may be fresh, dried, fermented, rolled, pressed, crushed and/or any combination thereof.

The leaves used may be are those from coconut and other edible palms such as areca (betel), date, acai, peach, snake, Butia, Chilean Wine, Saw Palmetto, Guadalupe, California Fan palms and those from the edible species of several species of Acrocomia, Actinorhytis, Allagoptera, Astrocaryum, Attalea, Bactris, Borassus, Calamus, Carpoxylon, Chamaerops, Clinostigma, Copernicia, Cryosophila, Daemonorops, Dypsis, Gulubia, Hyphaene, Jubaeaopsis, Latania, Loxococcos, Nypa, Oenocarpus, Parajubaea, Phoenix, Dactylifera, Pinanga, Ptychococcus, Sabal and Syagrus.

The use of the water soluble oil palm leaf powder and concentrate formulated with water dispersible oil palm as food ingredient, beverage ingredient, aroma and flavoring agent, active ingredient, nutricosmetics, cosmetics, cosmeceutics, toiletry ranges, supplements, instant food and nutritional formulations, natural preservative, oxidative retardant, functional food, pharmaceutics, additives, colorant and animal feed ingredient.

In yet another embodiment of the present invention, it is provided a method for producing water soluble oil palm leaf powder and concentrate, wherein the method includes the steps of:

(a) cleaning the leaves with water or an acid with pH lower than 5.5 and salts to produce an extract;

(b) extracting the oil palm leaves with a solvent which has polarity index above 2.5 such as methanol, ethanol or ethyl acetate or any combination thereof, especially catechins or ethanol and water which are generally recognized as safe (GRAS) for food consumption;

(c) filtering and/or centrifuging the extract;

(d) adding additives and/or stabilisers such as glucose, sucrose, fructose, starch, sodium hydroxide, acidity regulator, sodium chloride, vitamins and minerals; and

(e) removing moisture from the extract from step (d) to form the water soluble oil palm leaf powder and concentrate.

The leaves in step (a) may be cleansed by washing, soaking, immersing, stirring with water or an acid with pH lower than 5.5 such as acetic acid, lactic acid, citric acid, tartaric acid and malic acid and salts such as sodium chloride, sodium acetate, potassium chloride and magnesium chloride and/or any combinations thereof.

Step (a) may be aided by decellularization means such as juicing, stirring, mixing, blending, heating, steam distillation, homogenization, sonication, microwave, pulse-electric field, pressurised, supercritical fluid, ionic fluid and subcritical fluid.

The leaves in step (b) may be dried and separated to different size ranges, distinctively: water insoluble range (>500 μm), water dispersible range (>100 μm) and extraction range.

Step (d) may be conducted using means such as autoclaving, pasteurization, UHT, tyndallisation, retort, boiling, cooking, sonication, microwave, pulse-electric field or radiations.

Step (e) may be conducted by drying and/or dehydrating the extract.

The leaves may be fresh, dried, fermented, rolled, pressed, crushed and/or any combination thereof.

The leaves used may be are those from coconut and other edible palms such as areca (betel), date, acai, peach, snake, Butia, Chilean Wine, Saw Palmetto, Guadalupe, California Fan palms and those from the edible species of several species of Acrocomia, Actinorhytis, Allagoptera, Astrocaryum, Attalea, Bactris, Borassus, Calamus, Carpoxylon, Chamaerops, Clinostigma, Copernicia, Cryosophila, Daemonorops, Dypsis, Gulubia, Hyphaene, Jubaeaopsis, Latania, Loxococcos, Nypa, Oenocarpus, Parajubaea, Phoenix, Dactylifera, Pinanga, Ptychococcus, Sabal and Syagrus.

The use of the water soluble oil palm leaf powder and concentrate formulated with water dispersible oil palm as food ingredient, beverage ingredient, aroma and flavoring agent, active ingredient, nutricosmetics, cosmetics, cosmeceutics, toiletry ranges, supplements, instant food and nutritional formulations, natural preservative, oxidative retardant, functional food, pharmaceutics, additives, colorant and animal feed ingredient.

Also, there is further provided a method for producing water soluble oil palm leaf powder and concentrate, wherein the method includes the steps of:

(a) cleaning the leaves with water or an acid with pH lower than 5.5 and salts to produce an extract;

(b) extracting the oil palm leaves with a solvent which has polarity index above 2.5 such as methanol, ethanol or ethyl acetate or any combination thereof, especially catechins or ethanol and water which are generally recognized as safe (GRAS) for food consumption;

(c) filtering and/or centrifuging the extract;

(d) adding a buffer system or buffering agent such as citric acid, acetic acid, phosphate buffer, acetate buffer in order to maintain the pH of the powder to be the range of pH 3-8; and

(e) removing moisture from the extract from step (d) to form the water soluble oil palm leaf powder and concentrate.

The leaves in step (a) may be cleansed by washing, soaking, immersing, stirring with water or an acid with pH lower than 5.5 such as acetic acid, lactic acid, citric acid, tartaric acid and malic acid and salts such as sodium chloride, sodium acetate, potassium chloride and magnesium chloride and/or any combinations thereof.

Step (a) may be aided by decellularization means such as juicing, stirring, mixing, blending, heating, steam distillation, homogenization, sonication, microwave, pulse-electric field, pressurised, supercritical fluid, ionic fluid and subcritical fluid.

The leaves in step (b) may be dried and separated to different size ranges, distinctively: water insoluble range (>500 μm), water dispersible range (>100 μm) and extraction range.

Step (d) may be conducted using means such as autoclaving, pasteurization, UHT, tyndallisation, retort, boiling, cooking, sonication, microwave, pulse-electric field or radiations.

Step (e) may be conducted by drying and/or dehydrating the extract.

The leaves may be fresh, dried, fermented, rolled, pressed, crushed and/or any combination thereof.

The leaves used may be are those from coconut and other edible palms such as areca (betel), date, acai, peach, snake, Butia, Chilean Wine, Saw Palmetto, Guadalupe, California Fan palms and those from the edible species of several species of Acrocomia, Actinorhytis, Allagoptera, Astrocaryum, Attalea, Bactris, Borassus, Calamus, Carpoxylon, Chamaerops, Clinostigma, Copernicia, Cryosophila, Daemonorops, Dypsis, Gulubia, Hyphaene, Jubaeaopsis, Latania, Loxococcos, Nypa, Oenocarpus, Parajubaea, Phoenix, Dactylifera, Pinanga, Ptychococcus, Sabal and Syagrus.

The use of the water soluble oil palm leaf powder and concentrate formulated with water dispersible oil palm as food ingredient, beverage ingredient, aroma and flavoring agent, active ingredient, nutricosmetics, cosmetics, cosmeceutics, toiletry ranges, supplements, instant food and nutritional formulations, natural preservative, oxidative retardant, functional food, pharmaceutics, additives, colorant and animal feed ingredient.

Further, there is provided a method for producing water soluble oil palm leaf powder and concentrate, wherein the method includes the steps of:

(a) cleaning the leaves with water or an acid with pH lower than 5.5 and salts to produce an extract;

(b) extracting the oil palm leaves with a solvent which has polarity index above 2.5 such as methanol, ethanol or ethyl acetate or any combination thereof, especially catechins or ethanol and water which are generally recognized as safe (GRAS) for food consumption;

(c) filtering and/or centrifuging the extract;

(d) adding an encapsulation agent and/or stabilisers such as maltodextrin, cyclodextrin, gelatin, collagen, sodium caseinate, gum such as Arabic, locust bean, Ghatti, guar, Steaculia, Karaya, Tragacanth, alginates, agar-agar, pectin, carrageenan, protein hydrolysates or any combination thereof; and

(e) microencapsulating the extract from step (d) to form water soluble oil palm leaf powder and concentrate.

The leaves in step (a) may be cleansed by washing, soaking, immersing, stirring with water or an acid with pH lower than 5.5 such as acetic acid, lactic acid, citric acid, tartaric acid and malic acid and salts such as sodium chloride, sodium acetate, potassium chloride and magnesium chloride and/or any combinations thereof.

Step (a) may be aided by decellularization means such as juicing, stirring, mixing, blending, heating, steam distillation, homogenization, sonication, microwave, pulse-electric field, pressurised, supercritical fluid, ionic fluid and subcritical fluid.

The leaves in step (b) may be dried and separated to different size ranges, distinctively: water insoluble range (>500 μm), water dispersible range (>100 μm) and extraction range.

Step (d) may be conducted using means such as autoclaving, pasteurization, UHT, tyndallisation, retort, boiling, cooking, sonication, microwave, pulse-electric field or radiations.

Step (e) may be conducted by drying and/or dehydrating the extract.

The leaves may be fresh, dried, fermented, rolled, pressed, crushed and/or any combination thereof.

The leaves used may be are those from coconut and other edible palms such as areca (betel), date, acai, peach, snake, Butia, Chilean Wine, Saw Palmetto, Guadalupe, California Fan palms and those from the edible species of several species of Acrocomia, Actinorhytis, Allagoptera, Astrocaryum, Attalea, Bactris, Borassus, Calamus, Carpoxylon, Chamaerops, Clinostigma, Copernicia, Cryosophila, Daemonorops, Dypsis, Gulubia, Hyphaene, Jubaeaopsis, Latania, Loxococcos, Nypa, Oenocarpus, Parajubaea, Phoenix, Dactylifera, Pinanga, Ptychococcus, Sabal and Syagrus.

The use of the water soluble oil palm leaf powder and concentrate formulated with water dispersible oil palm as food ingredient, beverage ingredient, aroma and flavoring agent, active ingredient, nutricosmetics, cosmetics, cosmeceutics, toiletry ranges, supplements, instant food and nutritional formulations, natural preservative, oxidative retardant, functional food, pharmaceutics, additives, colorant and animal feed ingredient.

### EXAMPLE

Materials and Method

Moisture Content

Moisture content of tea powders was determined according to AOAC Official Method 934.06. The moisture content is expressed as percentage by mass (%).

Solubility

About 5 g of each sample (WO were suspended in 50 mL of water at room temperature in a centrifuge tube. The suspension was stirred intermittently for 30 minutes prior to centrifugation at 10000 rpm for 10 minutes. The supernatant was completely drained into a weighed evaporating dish and dried to constant weight at 105° C. The weight of the solids recovered after drying (W2) was used to calculate the water solubility (%) as followed:

$$S ( \% ) = \frac{W 2}{W 1} \times 100$$

Pellet left in the centrifuge tubes was also observed. Analyses were done in triplicate.

Dispersibility

Distilled water (10 ml), at 25±1° C., was poured into a 50 ml beaker. Approximately 1 g of powder was added into the beaker and manually stirred 1 minute and allowed to rest for 30 minutes for the suspension particles to settle down before the supernatant was carefully decanted through a sieve (212 μh). The sieved soymilk (10 ml) was transferred to a weighed and dried aluminum pan and dried for 4 h in a hot air oven at 105±1° C. The dispersibility of the powder was calculated as follows:

$$D ( \% ) = \frac{( 10 + a ) \times \% TS}{a \times \frac{100 - b}{100}}$$

where a=amount of powder (g) being used, b=moisture content in the powder, and % TS=dry matter in percentage in the reconstituted soymilk after it has been passed through the sieve. Analyses were done in triplicate.

Sensory Evaluation

The sensory characteristics of six different tea beverages were evaluated by 80 non-trained panelists at the Malaysian Palm Oil Board (MPOB). Six tea beverages include commercial water soluble green tea, commercial green tea, crude oil palm leaves tea, water soluble oil palm leaves tea, water dispersible oil palm leaves tea and formulated oil palm leaves tea. One percent (1%) w/v of tea beverage was prepared by infusing the respective tea with boiling water for 1 minute followed by sieving. Warm tea was served to the panelists individually. In addition, panelists were asked to rinse their mouth and take a bite of plain cracker in between each tasting. Evaluation of overall preference on performed using a 9-point scale ranging from extremely desirable (9) to undesirable (1).

Statistical Analysis

The significant differences of mean values were analysed by means of ANOVA followed by Tukey HSD posthoc test at 95% confidence level using Minitab Statistical Analysis Software (Minitab Inc., State College, PA, USA). All analyses were performed independently (n≦3).

Results and Discussion

Solubility: Physical Observations

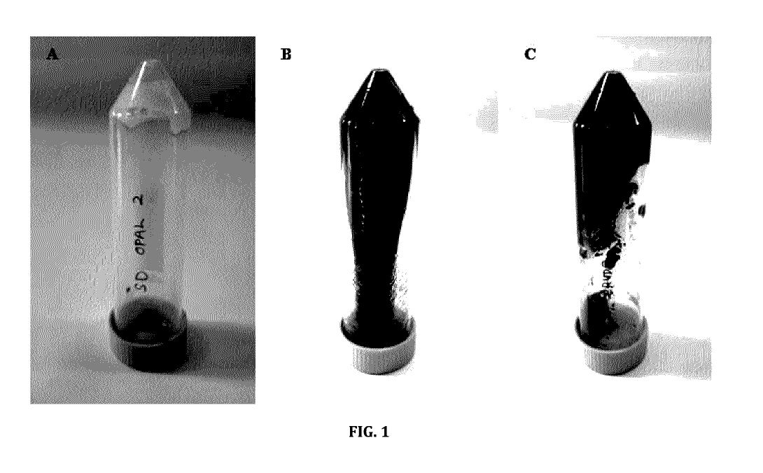

FIG. 1 shows the observations on the solubility of different oil palm leaves (OPAL) preparations upon vigorous stirring and centrifugation. A. water soluble OPAL. B. water dispersible OPAL. C. Crude OPAL leaves.

Physical Properties of OPAL Tea Preparations

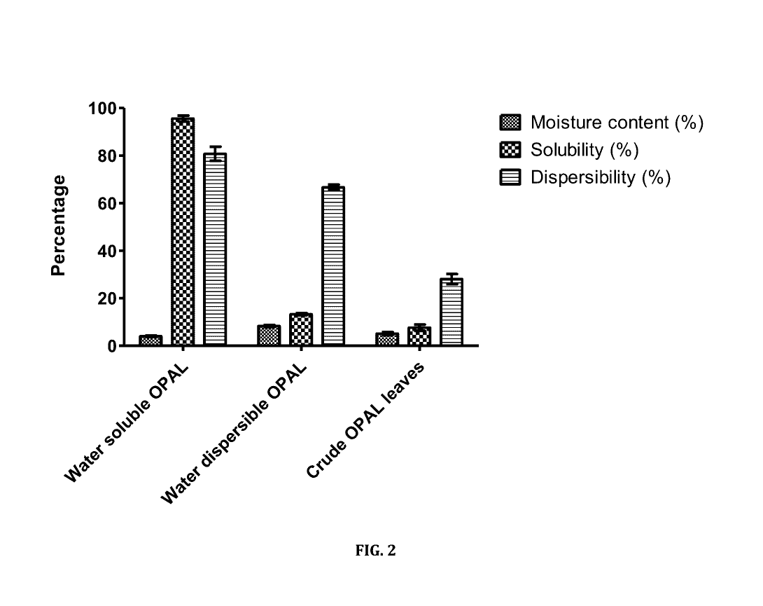

FIG. 2 shows the moisture content, percent solubility and percent dispensability of water soluble OPAL, water dispersible OPAL and crude OPAL leaves.

Sensory Evaluation: Overall Preference

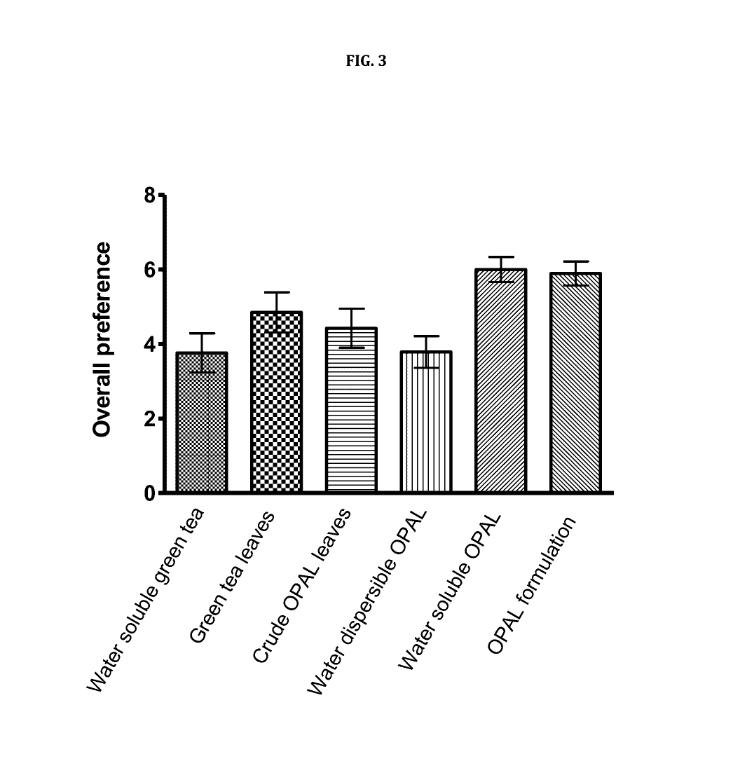

FIG. 3 shows the overall preference of six tea beverages characterized by 80 non-trained panelists. Preference was evaluated by a 9-point hedonic scale where 1 characterises extreme dislike while 9 chracterises extreme like. Error bar depicts mean with 95% confidence level.

1. A method for producing water soluble oil palm leaf powder and concentrate, wherein the method includes the steps of:
(a) cleaning the leaves with water or an acid with pH lower than 5.5 and salts to produce an extract;
(b) extracting the oil palm leaves with a solvent which has polarity index above 2.5 such as methanol, ethanol or ethyl acetate or any combination thereof, especially catechins or ethanol and water which are generally recognized as safe (GRAS) for food consumption;
(c) filtering and/or centrifuging the extract;
(d) sterilizing the extract; and
(e) microencapsulating the extract from step (d) to form the water soluble oil palm leaf powder and concentrate.

2. The method as claimed in claim 1, wherein the leaves in step (a) are cleansed by washing, soaking, immersing, stirring with water or an acid with pH lower than 5.5 such as acetic acid, lactic acid, citric acid, tartaric acid and malic acid and salts such as sodium chloride, sodium acetate, potassium chloride and magnesium chloride and/or any combinations thereof.

3. The method as claimed in claim 1, wherein step (a) is aided by decellularization means such as juicing, stirring, mixing, blending, heating, steam distillation, homogenization, sonication, microwave, pulse-electric field, pressurised, supercritical fluid, ionic fluid and subcritical fluid.

4. The method as claimed in claim 1, wherein the leaves in step (b) are dried and separated to different size ranges, distinctively: water insoluble range (>500 μm), water dispersible range (>100 μm) and extraction range.

5. The method as claimed in claim 1, wherein step (d) is conducted using means such as autoclaving, pasteurization, UHT, tyndallisation, retort, boiling, cooking, sonication, microwave, pulse-electric field or radiations.

6. (canceled)

7. The method as claimed in claim 1, wherein the leaves include at least one of:
leaves from coconut or other edible palms of a group that consists of such as areca (betel), date, acai, peach, snake, Butia, Chilean Wine, Saw Palmetto, Guadalupe, California Fan palms;
leaves from other coconut or other edible palms; and;
leaves from edible species selected from among a group that consists of Acrocomia, Actinorhytis, Allagoptera, Astrocaryum, Attalea, Bactris, Borassus, Calamus, Carpoxylon, Chamaerops, Clinostigma, Copernicia, Cryosophila, Daemonorops, Dypsis, Gulubia, Hyphaene, Jubaeaopsis, Latania, Loxococcos, Nypa, Oenocarpus, Parajubaea, Phoenix, Dactylifera, Pinanga, Ptychococcus, Sabal and Syagrus.

8. The use of the water soluble oil palm leaf powder and concentrate as claimed in claim 1, formulated with water dispersible oil palm as food ingredient, beverage ingredient, aroma and flavoring agent, active ingredient, nutricosmetics, cosmetics, cosmeceutics, toiletry ranges, supplements, instant food and nutritional formulations, natural preservative, oxidative retardant, functional food, pharmaceutics, additives, colorant and animal feed ingredient.

9. A method for producing water soluble oil palm leaf powder and concentrate, wherein the method includes the steps of:
(a) cleaning the leaves with water or an acid with pH lower than 5.5 and salts to produce an extract;
(b) extracting the oil palm leaves with a solvent which has polarity index above 2.5 such as methanol, ethanol or ethyl acetate or any combination thereof, especially catechins or ethanol and water which are generally recognized as safe (GRAS) for food consumption;
(c) filtering and/or centrifuging the extract;
(d) adding additives and/or stabilisers such as glucose, sucrose, fructose, starch, sodium hydroxide, acidity regulator, sodium chloride, vitamins and minerals; and
(e) microencapsulating the extract from step (d) to form water soluble oil palm leaf powder and concentrate.

10. The method as claimed in claim 9, wherein the leaves in step (a) are cleansed by washing, soaking, immersing, stirring with water or an acid with pH lower than 5.5 such as acetic acid, lactic acid, citric acid, tartaric acid and malic acid and salts such as sodium chloride, sodium acetate, potassium chloride and magnesium chloride and/or any combinations thereof.

11. The method as claimed in claim 9, wherein step (a) is aided by decellularization means such as juicing, stirring, mixing, blending, heating, steam distillation, homogenization, sonication, microwave, pulse-electric field, pressurised, supercritical fluid, ionic fluid and subcritical fluid.

12. The method as claimed in claim 9, wherein the leaves in step (b) are dried and separated to different size ranges, distinctively: water insoluble range (>500 μm), water dispersible range (>100 μm) and extraction range.

13. The method as claimed in claim 9, wherein step (d) is conducted using means such as autoclaving, pasteurization, UHT, tyndallisation, retort, boiling, cooking, sonication, microwave, pulse-electric field or radiations.

14. (canceled)

15. The method as claimed in claim 9, wherein the leaves include at least one of:
leaves from coconut or other edible palms of a group that consists of such as areca (betel), date, acai, peach, snake, Butia, Chilean Wine, Saw Palmetto, Guadalupe, California Fan palms;
leaves from other coconut or other edible palms; and
leaves from edible species selected from among a group that consists of Acrocomia, Actinorhytis, Allagoptera, Astrocaryum, Attalea, Bactris, Borassus, Calamus, Carpoxylon, Chamaerops, Clinostigma, Copernicia, Cryosophila, Daemonorops, Dypsis, Gulubia, Hyphaene, Jubaeaopsis, Latania, Loxococcos, Nypa, Oenocarpus, Parajubaea, Phoenix, Dactylifera, Pinanga, Ptychococcus, Sabal and Syagrus.

16. The use of the water soluble oil palm leaf powder and concentrate as claimed in claim 9, formulated with water dispersible oil palm as food ingredient, beverage ingredient, aroma and flavoring agent, active ingredient, nutricosmetics, cosmetics, cosmeceutics, toiletry ranges, supplements, instant food and nutritional formulations, natural preservative, oxidative retardant, functional food, pharmaceutics, additives, colorant and animal feed ingredient.

17. A method for producing water soluble oil palm leaf powder and concentrate, wherein the method includes the steps of:
(a) cleaning the leaves with water or an acid with pH lower than 5.5 and salts to produce an extract;
(b) extracting the oil palm leaves with a solvent which has polarity index above 2.5 such as methanol, ethanol or ethyl acetate or any combination thereof, especially catechins or ethanol and water which are generally recognized as safe (GRAS) for food consumption;
(c) filtering and/or centrifuging the extract;
(d) adding a buffer system or buffering agent such as citric acid, acetic acid, phosphate buffer, acetate buffer in order to maintain the pH of the powder to be the range of pH 3-8; and
(e) microencapsulating the extract from step (d) to form water soluble oil palm leaf powder and concentrate.

18. The method as claimed in claim 17, wherein the leaves in step (a) are cleansed by washing, soaking, immersing, stirring with water or an acid with pH lower than 5.5 such as acetic acid, lactic acid, citric acid, tartaric acid and malic acid and salts such as sodium chloride, sodium acetate, potassium chloride and magnesium chloride and/or any combinations thereof.

19. The method as claimed in claim 17, wherein step (a) is aided by decellularization means such as juicing, stirring, mixing, blending, heating, steam distillation, homogenization, sonication, microwave, pulse-electric field, pressurised, supercritical fluid, ionic fluid and subcritical fluid.

20. The method as claimed in claim 17, wherein the leaves in step (b) are dried and separated to different size ranges, distinctively: water insoluble range (>500 μm), water dispersible range (>100 μm) and extraction range.

21. The method as claimed in claim 17, wherein step (d) is conducted using means such as autoclaving, pasteurization, UHT, tyndallisation, retort, boiling, cooking, sonication, microwave, pulse-electric field or radiations.

22. (canceled)

23. (canceled)

24. The use of the water soluble oil palm leaf powder and concentrate as claimed in claim 17, formulated with water dispersible oil palm as food ingredient, beverage ingredient, aroma and flavoring agent, active ingredient, nutricosmetics, cosmetics, cosmeceutics, toiletry ranges, supplements, instant food and nutritional formulations, natural preservative, oxidative retardant, functional food, pharmaceutics, additives, colorant and animal feed ingredient.

25.-68. (canceled)
